(19) United States
(12) Patent Application Publication
(10) Pub. No.: US 2013/0129860 A1
(43) Pub. Date: May 23, 2013

(54) NUTRITIONAL COMPOSITIONS COMPRISING FRUIT FLAKES CONTAINING DOCOSAHEXAENOIC ACID

(71) Applicant: Gabriela Chavez, Queretaro (MX)

(72) Inventor: Gabriela Chavez, Queretaro (MX)

(73) Assignee: NESTEC S.A., Vevey (CH)

(21) Appl. No.: 13/519,678

(22) PCT Filed: Nov. 5, 2010
(86) PCT No.: PCT/MX2010/000126

§ 371 Date: Dec. 31, 2012

Related U.S. Application Data
(60) Provisional application No. 61/290,609, filed on Dec. 29, 2009.

(51) Int. Cl. A23L 1/30

(52) U.S. Cl. CPC A23L 1/3008
USPC 426/2; 426/640; 426/71; 426/61; 426/62; 426/590; 426/473; 426/392; 426/615; 514/560

(57) ABSTRACT

Nutritional compositions and methods for making and using said nutritional compositions are provided. In a general embodiment, the present disclosure provides a nutritional composition that has fruit flakes that include docosahexaenoic acid. The docosahexaenoic acid can be incorporated directly in the fruit flakes.

### BACKGROUND

The present disclosure relates in general to health and nutrition. More specifically, the present disclosure relates to nutritional compositions that have fruit flakes that include docosahexaenoic acid and methods for producing and using said nutritional compositions.

There are many types of nutritional compositions currently on the market. Nutritional compositions can be directed towards particular types of consumers, for example the young, the elderly, the athletic, etc., based on specific ingredients of the nutritional composition. The nutritional compositions contain flakes of dehydrated fruits, which are known in the market. However, there is still a need for fruit flakes that contain additional micronutrients and macronutrients.

### BRIEF DESCRIPTION OF THE INVENTION

Nutritional compositions that have fruit flakes and methods for producing and using said nutritional compositions are provided. In a general embodiment, the present disclosure provides a nutritional composition that has fruit flakes that include docosahexaenoic acid. The docosahexaenoic acid can be incorporated directly in the fruit flakes. The docosahexaenoic acid can be derived from fish oil and preferably is encapsulated. The fruit flakes can be made from any suitable fruit including apple, mango, peach, etc.

In one embodiment, the nutritional composition is free from preservatives. Even without preservatives, the fruit flakes can be stable (for example, do not deteriorate or oxidize) for 12 months or more.

The nutritional composition can be in a formulation intended for any infant. The active ingredients in the nutritional composition can also be provided as a modular product. A modular product can be defined as a method for supplying one or more specific nutrients as a supplement and is not intended to be used as the sole source of nutrition. Moreover, the nutritional compositions can be nonperishable and can have a good shelf life at room temperature or even at higher ambient temperatures that may occur during distribution.

In one embodiment, the nutritional composition further includes one or more prebiotics. The prebiotic can be fructooligosaccharide, inulin, lactulose, galactooligosaccharides, gum arabic, soy oligosaccharides, xylooligosaccharides, isomaltooligosaccharides, gentiooligosaccharides, lactosucrose, gluco-oligosaccharides, pectic oligosaccharides, resistant starches, sugar alcohols or a combination thereof.

In one embodiment, the nutritional composition further includes one or more probiotics. The probiotic can be Saccharomyces, Debaryomyces, Candida, Pichia, Torulopsis, Aspergillus, Rhizopus, Mucor, Penicillium, Torulopsis, Bifidobacterium, Bacteroides, Clostridium, Fusobacterium, Melissococcus, Propionibacterium, Streptococcus, Enterococcus, Lactococcus, Staphylococcus, Peptostreptococcus, Bacillus, Pediococcus, Micrococcus, Leuconostoc, Weissella, Aerococcus, Oenococcus, Lactobacilli or a combination thereof.

In another embodiment, the nutritional composition further includes one or more amino acids. The amino acids can be Isoleucine, Alanine, Leucine, Asparagine, Lysine, Aspartate, Methionine, Cystine, Phenylalanine, Glutamate, Threonine, Glutamine, Tryptophan, Glycine, Valine, Proline, Serine, Tyrosine, Arginine, Histidine or a combination thereof.

In one embodiment, the nutritional composition further includes one or more symbiotics, phytonutrients, antioxidants, and/or partially hydrolyzed guar gum.

In one embodiment, the nutritional composition is in a form that can be administered, such as pharmaceutical formulations, nutritional formulations, dietetic supplements, functional foodstuffs, beverage products or a combination thereof.

In another embodiment, the present disclosure provides a fruit flake that includes docosahexaenoic acid. The fruit flake can be apple flake, mango flakes, peach flakes or a combination thereof. The fruit flake can be free from preservatives.

The fruit flakes can be 100% fruit with docosahexaenoic acid and supplied in a convenient packet. The fruit flakes can be poured into a vessel and water and can be added to produce a fruit purée. The fruit purée can have a suitable consistency and flavor for infants and contribute to the development of children's eyes and brain. Moreover, addition of water to create a fruit purée provides a carer a feeling of compromise for making foods for the child.

In an alternative embodiment, the present disclosure provides a method for producing a nutritional composition. The method comprises incorporating docosahexaenoic acid in a fruit flake.

The incorporation can be effected using any suitable process.

In yet another embodiment, the present disclosure provides a method for producing fruit flakes. The method comprises pureeing a fruit to form a fruit purée, adding docosahexaenoic acid to the fruit purée, drying the fruit purée, and flaking (for example, cutting, chopping, grinding, etc.) the dried fruit purée into fruit flakes. In one embodiment, the method further comprises sifting the fruit flakes. The method can further comprise packing the fruit flakes in any suitable container. The method can be carried out in aseptic conditions.

In another embodiment, the present disclosure provides a method for producing a food for infants. The method comprises providing fruit flakes that include docosahexaenoic acid and adding a liquid to the fruit flakes to form a fruit purée.

In an alternative embodiment, the present disclosure provides a method for providing nutrition for an infant. The method comprises providing fruit flakes that include docosahexaenoic acid, adding a liquid to the fruit flakes to form a fruit purée, and administering the fruit purée to the infant.

One advantage of the present disclosure is that it provides an improved nutritional composition that includes docosahexaenoic acid.

Another advantage of the present disclosure is that it provides a method for producing an improved nutritional composition. Yet another advantage of the present disclosure is that it provides a fruit flake that includes docosahexaenoic acid.

Yet another advantage of the present disclosure is that it provides an improved method for improving the nutrition of an infant.

The further features and advantages are described herein, and will be clear from the following detailed description and the drawings.

### BRIEF DESCRIPTION OF THE DRAWINGS

FIG. 1 shows a scheme of one embodiment of a manufacturing process for making fruit flakes.

### DETAILED DESCRIPTION

The present disclosure relates to nutritional compositions and methods for making nutritional compositions. In a general embodiment, the present disclosure provides a nutritional composition that has fruit flakes that include docosahexaenoic acid (“DHA”). The fruit flakes can be made from any suitable fruit including apple, mango, peach, etc.

The DHA can be incorporated directly in the fruit flakes by mixing or combining during the fruit flake manufacturing process. The DHA can be derived from fish oil. The DHA can be, for example, in the form of encapsulated DHA powder (for example, tuna oil microencapsulated with gelatin). Docosahexaenoic acid (commonly known as DHA; 22:6(ω-3), all-ciss-docosa-4,7,10,13,16,19-hexaenoic acid; trivial name cervonic acid) is an omega-3 essential fatty acid. With respect to its chemical structure, DHA is carboxylic acid with a chain of 22—carbons and six cis double bonds. The first double bond is positioned on the third carbon from the omega end.

DHA is the most abundant essential fatty acid (polyunsaturated fatty acids (“PUFAs”)) in the brain and the retina. It comprises 40% of PUFAs in the brain and 60% of PUFAs in the retina. 50% of the weight of the plasma membrane of the neuron is composed of DHA. DHA contributes to development of the brain and of the eyes especially in children under 2 years of age.

Fish oils are rich in DHA. Most of the DHA in fish and more complex organisms derived from photosynthetic microalgae and heterotrophs, and becomes more and more concentrated in the organisms as they move up to the food chain. DHA is also manufactured commercially from microalgae. The manufactured DHA that uses microalgae is vegetarian. Most animals make very little DHA via the metabolism, including humans. However, small amounts are manufactured internally through the consumption of α-linolenic acid, an omega-3 fatty acid found in plants, animals and milk. As used herein, the term “fruit flake” includes fruit particles. The fruit particles can have any suitable diameter, density and moisture content. The fruit particles can be partially or completely soluble in a liquid. Preferably, the fruit particles are dehydrated.

As used herein, the term “nutritional composition” includes, but is not limited to, supplementing the nutritional compositions, incomplete or partial nutritional compositions, and disease or condition of specific nutritional compositions. A complete nutritional composition (i.e. which contains all the essential macro- and micronutrients) can be used as a sole source of nutrition for the patient. Patients can receive 100% of their nutritional requirements from said complete nutritional composition. An incomplete or partial nutritional composition does not contain all the essential macro- and micronutrients and cannot be used as a sole source of nutrition for the patient. The partial or incomplete nutritional compositions can be used as a nutritional supplement. A disease or condition of the specific nutritional composition is a composition that delivers nutrients or pharmaceutical products and can be a partial or complete nutritional composition.

In another embodiment, the present disclosure provides a fruit flake that includes docosahexaenoic acid. The fruit flake can be made from any suitable fruit such as apples, mangos, peaches, etc. The fruit flake can be free from preservatives yet is stable for 12 months or more.

The fruit flakes can be 100% fruit with DHA and supplied in a convenient packet. The fruit flakes can be poured into a vessel and water can be added to the fruit flakes in any suitable amount to produce a fruit purée. The fruit purée can have suitable consistency and flavor for infants and can contribute to the development of the brain and eyes of the infant. In one embodiment, the nutritional composition further includes one or more prebiotics. As used herein, a prebiotic is a selective fermented ingredient that allows specific changes, both in the composition and/or in the activity of the gastrointestinal microflora, that confers benefits for wellbeing and health. Nonlimiting examples of prebiotics include fructooligosaccharides, inulin, lactulose, galactooligosaccharides, gum arabic, soy oligosaccharides, xylooligosaccharides, isomaltooligosaccharides, gentiooligosaccharides, lactosucrose, glucooligosaccharides, pectic oligosaccharides, resistant starches, sugar alcohols or a combination thereof.

In one embodiment, the nutritional composition further includes one or more probiotics. As used herein, probiotics are defined as microorganisms (for example, live) that might confer health benefits in the host when it is administered in suitable amounts.

Nonlimiting examples of probiotics include Saccharomyces, Debaryomyces, Candida, Pichia, Torulopsis, Aspergillus, Rhizopus, Mucor, Penicillium, Torulopsis, Bifidobacterium, Bacteroides, Clostridium, Fusobacterium, Melissococcus, Propionibacterium, Streptococcus, Enterococcus, Lactococcus, Staphylococcus, Peptostreptococcus, Bacillus, Pediococcus, Micrococcus, Leuconostoc, Weissella, Aerococcus, Oenococcus, Lactobacilli or a combination thereof.

In another embodiment, the nutritional composition further includes one or more amino acids. Nonlimiting examples of amino acids include Isoleucine, Alanine, Leucine, Asparagine, Lysine, Aspartate, Methionine, Cysteine, Phenylalanine, Glutamate, Threonine, Glutamine, Tryptophan, Glycine, Valine, Proline, Serine, Tyrosine, Arginine, Histidine or a combination thereof.

In one embodiment, the nutritional composition further includes one or more symbiotics, phytonutrients and/or antioxidants. As used herein, a symbiotic is a supplement that contains both a prebiotic and a probiotic which work together to improve the microflora of the intestine. Nonlimiting examples of phytonutrients include quercetin, curcumin and limonene. The antioxidants are molecules capable of decreasing or preventing the oxidation of other molecules. Nonlimiting examples of antioxidants include vitamin A, carotenoids, vitamin C, vitamin E, selenium, flavonoids, polyphenols, lycopene, lutein, lignans, coenzyme Q10 (“CoQ10”) and glutathione.

In an alternative embodiment, the present invention offers the advantage of providing a stable means for supply of DHA by incorporating DHA directly in a fruit flake. Incorporation can be effected using any suitable mixing process. Surprisingly, it was found that incorporation of DHA directly in the fruit flake provides better stability for DHA and prevents oxidation of DHA, which easily suffers mechanical damage that causes the gelatin capsule to break, thus exposing the oil to the air and turning the DHA rancid.

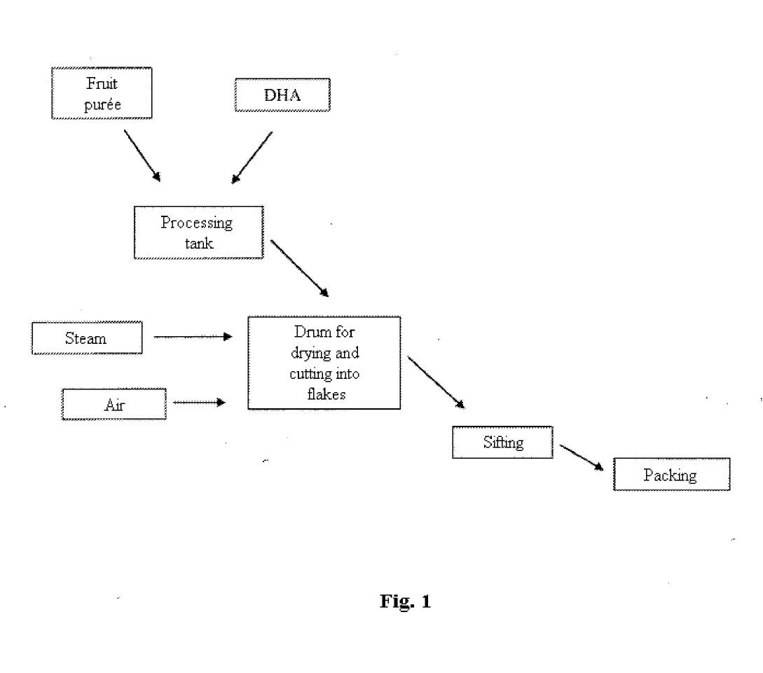

As shown in FIG. 1, one method for producing fruit flakes comprises pureeing a fruit to form a fruit purée, adding DHA to the fruit purée (for example, mixing or combining in a processing tank), drying the fruit purée, and cutting the dry fruit purée into fruit flakes. The dry fruit purée can be made into fruit flakes using any suitable method such as grinding or cutting the dry fruit purée. The methods can be carried out in aseptic conditions. The dry fruit flakes must combine critical parameters of thickness, density and moisture to maintain stability during their useful life.

For example, the fruit purée can be put in one or more drying drums and a flow of air provided for each of the drying drums. The air flow, the quality and the model can be modified as necessary for drying the fruit purée to the desired physical composition.

The revolutions per minute (rpm) of the drying drums can also be controlled for affecting the conditions of drying of the fruit purée. For example, the rpm can provide good results.

Once the fruit purée has been dried and has been transformed into flakes by cutting, grinding, etc., the method can further comprise sifting the fruit flakes.

This can be used for obtaining fruit flakes that have a specific size or diameter. The fruit flakes can be packed in any suitable container.

In another embodiment, the present disclosure provides a method for producing an infant food. The method comprises providing fruit flakes including docosahexaenoic acid and adding a liquid to the fruit flakes to form a fruit purée. For example, 16 grams of fruit flakes can be added to a bag of the feed bag type for a single portion of portions. The portion can contain 18 mg of DHA and can provide, when mixed with 80 ml of water, a fruit purée ready for eating and specially designed for infants or young children.

In an alternative embodiment, the present disclosure provides a method for providing nutrition to an infant. The method comprises providing fruit flakes that include docosahexaenoic acid, adding a liquid to the fruit flakes to form a fruit purée, and administering the purée to the infant. The liquid can include water, milk, a formula or any suitable fruit juice. Any suitable amount of liquid can be combined or mixed with the fruit flakes to form a fruit purée that has a desired consistency. The fruit purée can contribute to the development of the brain and eyes of the infant.

It must be understood that various changes and modifications to the preferred embodiments described herein will be apparent to a person skilled in the art. Said changes and modifications can be made without departing from the spirit and scope of the present matter and without decreasing its intended advantages. Therefore it is intended that some changes and modifications are converted by the appended claims.

1. A nutritional composition, characterized in that it comprises fruit flakes that include docosahexaenoic acid.

2. The nutritional composition as claimed in claim 1, further characterized in that the fruit flakes are selected from the group consisting of apple flakes, mango flakes, peach flakes and a combination thereof.

3. The nutritional composition as claimed in claim 1, further characterized in that the nutritional composition is free from preservatives.

4. The nutritional composition as claimed in claim 1, further characterized in that the docosahexaenoic acid is derived from fish oil.

5. The nutritional composition as claimed in claim 1, characterized in that it further comprises a prebiotic.

6. The nutritional composition as claimed in claim 5, further characterized in that the prebiotic is selected from the group consisting of partially hydrolyzed guar gum, fructooligosaccharides, inulin, lactulose, galactooligosaccharides, gum arabic, soy oligosaccharides, xylooligosaccharides, isomaltooligosaccharides, gentioologosaccharides, lactosucrose, glucooligosaccharides, pectic oligosaccharides, resistant starches, sugar alcohols and a combination of these.

7. The nutritional composition as claimed in claim 1, further characterized in that it comprises a probiotic.

8. The nutritional composition as claimed in claim 7, further characterized in that the probiotic is selected from the group consisting of Saccharomyces, Debaryomyces, Candida, Pichia, Torulopsis, Aspergillus, Rhizopus, Mucor, Penicillium, Torulopsis, Bifidobacterium, Bacteroides, Clostridium, Fusobacterium, Melissococcus, Propionibacterium, Streptococcus, Enterococcus, Lactococcus, Staphylococci, Peptostreptococcus, Bacillus, Pediococcus, Micrococcus, Leuconostoc, Weissella, Aerococcus, Oenococcus, Lactobacillus, and combinations thereof.

9. The nutritional composition as claimed in claim 1, further characterized in that it comprises a symbiotic.

10. The nutritional composition as claimed in claim 1, further characterized in that it comprises an amino acid.

11. The nutritional composition as claimed in claim 10, further characterized in that the amino acid is selected from the group consisting of Isoleucine, Alanine, Leucine, Asparagine, Lysine, Aspartate, Methionine, Cysteine, Phenylalanine, Glutamate, Threonine, Glutamine, Tryptophan, Glycine, Valine, Proline, Serine, Tyrosine, Arginine, Histidine and a combination thereof.

12. The nutritional composition as claimed in claim 1, characterized in that it further comprises a phytonutrient.

13. The nutritional composition as claimed in claim 12, further characterized in that the phytonutrient is selected from the group consisting of quercetin, curcumin, limonene and a combination of these.

14. The nutritional composition as claimed in claim 1, characterized in that it further comprises an antioxidant.

15. The nutritional composition as claimed in claim 1, further characterized in that the nutritional composition is in a form that can be administered selected from the group consisting of pharmaceutical formulations, nutritional formulations, dietetic supplements, functional foodstuffs, and beverage products.

16. A fruit flake characterized in that it further comprises docosahexaenoic acid.

17. The fruit flake as claimed in claim 16, further characterized in that the fruit flake is selected from the group consisting of apple flakes, mango flakes, peach flakes and a combination thereof.

18. The fruit flake as claimed in claim 16, further characterized in that the fruit flake is free from preservatives.

19. The fruit flake as claimed in claim 16, further characterized in that the docosahexaenoic acid is derived from fish oil.

20. A method for producing a nutritional composition, said method comprising: incorporating docosahexaenoic acid in a fruit flake.

21. A method for producing fruit flakes, said method comprising:
pureeing a fruit to form a fruit purée;
adding docosahexaenoic acid to the fruit purée;
drying the fruit purée; and
cutting the dry fruit purée into fruit flakes.

22. The method as claimed in claim 21, characterized in that it further comprises sifting the fruit flakes.

23. The method as claimed in claim 21, further characterized in that it comprises packing the fruit flakes.

24. The method as claimed in claim 21, further characterized in that the fruit is selected from the group consisting of apple, mango, peach and a combination thereof.

25. The method as claimed in claim 21, further characterized in that the method is carried out in aseptic conditions.

26. A method for producing an infant food, said method comprising:
providing fruit flakes including docosahexaenoic acid; and
adding a liquid to the fruit flakes to form a fruit purée.

27. A method for supplying nutrition to an infant, said method comprising:
providing fruit flakes including docosahexaenoic acid;
adding a liquid to the fruit flakes to form a fruit purée; and
administering the fruit purée to an infant.

28. A method of stable supply of docosahexaenoic acid that comprises the steps of:
incorporating docosahexaenoic acid in a fruit flake;
adding a liquid to a fruit flake to form a fruit purée; and
administering the fruit purée to the infant.
